(19) United States
(12) Patent Application Publication
(10) Pub. No.: US 2008/0317078 A1
(43) Pub. Date: Dec. 25, 2008

(54) GREEN LASER MODULE PACKAGE

(75) Inventors: Heung-Woo Park, Suwon-si (KR); Jeong-Soo Kim, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD, Suwon (KR)

(21) Appl. No.: 12/142,703

(22) Filed: Jun. 19, 2008

(30) Foreign Application Priority Data
Jun. 22, 2007 (KR) 10-2007-0061893

(51) Int. Cl. H01S 3/04

(52) U.S. Cl. 372/36

(57) ABSTRACT

A green laser module package is disclosed. A green laser module package which generates a laser in a wavelength range of green visible lights comprising: a stem located on a basal surface of the green laser module package; a pumping light source that generates a pumping light; a laser medium that converts the pumping light into an infrared light; an optical crystal that converts the infrared light into a laser in wavelength range of green visible lights; a first thermoelectric element, located on the stem and thermally coupled to the pumping light source, that controls working temperature of the pumping light source; an optical part that reflects the green laser from the optical crystal in a perpendicular direction to an optical axis of the pumping light source; and a window that transmits the perpendicularly reflected green laser, toward outside of the green laser module package, is provided. The green laser module package can exclude an undesirable affects of external and inner heat by controlling working temperatures of components of the green laser module and minimize size and volume of the green laser module.

### CROSS-REFERENCE TO RELATED APPLICATIONS

This application claims the benefit of Korean Patent Application No. 10-2007-0061893 filed with the Korean Intellectual Property Office on Jun. 22, 2007, the disclosure of which is incorporated herein by reference in its entirety.

### BACKGROUND

1. Technical Field

The present invention relates to a laser module package. More particularly, the present invention relates to a green laser module package which generates a laser in wavelength range of green visible lights.

2. Description of the Related Art

Recent progresses in color display device c raise demand for small display devices like PDA (Personal Digital Assistants) and PMP (Portable Multimedia Player) as well as large display devices like TV and monitors. To realize a color display, a technology utilizing 3 primary colors (red, green, blue) by separating the 3 colors from a white light may be used. Also another technology utilizing 3 light sources for 3 primary colors respectively may be used.

In this case, a red light source and a blue light source may be a single laser diode light that generates a red light or a blue light. However, using a single laser diode light source to generate a green light does not reach to a commercial level.

Producing a green light directly from a single laser diode light source may not satisfy commercial requirements. Thus, for a green light source, converting a pumping light from a pumping light source to an infrared light and converting the infrared light to a green light by an optical crystal may be adopted. For example, a pumping light source may produce a pumping light of 808 nm wavelength. The pumping light may be converted to an infrared light of 1064 nm wavelength by a laser medium. The infrared light may be converted to a green laser of 532 nm wavelength by an optical crystal.

However, a problem against a green laser module package of the related art was that temperature change outside the package and heat generated during operation inside the package affects the components of the package (a pumping light source, a laser medium, an optical crystal) to vary wavelength and power of an output laser.

For example, for a pumping light source a 1° C. higher temperature inside the package make 0.3 nm wavelength variation of a pumping light from the pumping light source. Thus, a green laser module may produce an unstable output laser rather than a desirable green laser. Particularly, a green laser module has a smaller working temperature range of about 25˜35° C., compared a red laser module or a blue laser module with a working temperature range of about 10˜50° C.

Therefore, to guarantee more precise and stable operation of a green laser module package, working temperatures of each elements of the green laser module package would be adjusted properly. For each components of the green laser module (pumping light source, laser medium and, optical crystal) may have different temperature, sensitivity to heat and required working temperature, the working temperatures need to be controlled respectively.

### SUMMARY

An aspect of the invention is to provide a green laser module package that prevents an error and maximize accuracy, reliability and stability by controlling working temperatures of green laser module components.

Another aspect of the invention is to provide a green laser module package with a thermoelectric element that diminished effect of outside temperature and inside heat sources and minimize the module package.

Yet another aspect of the invention is to provide a green laser module package with a small size and volume, applicable to small color display devices such as a mobile phone, PMP and etc.

One aspect of the invention provides a green laser module package which generates a laser in a wavelength range of green visible lights. The green laser module package can include a stem located on a basal surface of the green laser module package, a pumping light source that generates a pumping light, a laser medium that converts the pumping light into an infrared light, an optical crystal that converts the infrared light into a laser in wavelength range of green visible lights, a first thermoelectric element, located on the stem and thermally coupled to the pumping light source, that controls working temperature of the pumping light source, an optical part that reflects the green laser from the optical crystal in a perpendicular direction to an optical axis of the pumping light source and a window that transmits the perpendicularly reflected green laser, toward outside of the green laser module package.

The pumping light source can generate a pumping light of about 808 nm wavelength. The laser medium can convert the pumping light of about 808 nm wavelength into an infrared light of about 1064 nm wavelength. The optical crystal can convert the infrared light of about 1064 nm wavelength into a laser of about 532 nm wavelength.

The laser medium can be of Nd:YVO4 (Neodymium: Yttrium Vanadate) and the optical crystal can be of KTP crystal Potassium-titanyl-phosphate crystal. An output surface of the laser medium and an input surface of the optical crystal can have a surface to surface contact.

The laser medium and the optical crystal may be located on the first thermoelectric element, and the first thermoelectric element can control a working temperature of the laser medium and the optical crystal.

An optical axis of the green laser from the window can be identical to the center axis of the green laser module package.

The green laser module package can include a thermistor that measures the working temperature of the pumping light source and delivers the measured working temperature to the first thermoelectric element.

The green laser module package can include a photo detector that monitors intensity of the green laser. The photo detector can monitor the intensity by detecting a partially reflected green laser from the window. The window may incline in a predetermined angle to the optical axis of the green laser and the photo detector may be aligned to detect a partially reflected green laser from the inclined window.

The photo detector can include a compound semiconductor photo absorption layer having a band gap larger than 1.6 eV. The compound semiconductor photo absorption layer can be a Si photo absorption layer and the photo detector can include a dielectric coating having a reflection ratio larger than 0.5 for an infrared lights of about 808 nm and 1064 nm wavelength, and having a reflection ratio smaller than 0.5 for a green light of about 532 nm wavelength. The compound semiconductor photo absorption layer can be composed of semiconductor selected from the group consisting of CdS, InGaN, AlGaN and their mixtures. The photo detector can include an optical filter that reflects or absorbs an infrared light of about 808 nm and about 1064 nm wavelength and transmits a green light of about 532 nm wavelength.

The green laser module package can include a second thermoelectric element that controls working temperature of the laser medium and the optical crystal and the second thermoelectric element controls the working temperature of the laser medium and the optical crystal, separately from the working temperature of the pumping light source. The stem can include a heat insulation part between the first thermoelectric element and the second thermoelectric element that separates thermally the first thermoelectric element from the second thermoelectric element.

The green laser module package can include plural leads to apply a driving voltage to the green laser module package and the plural leads penetrate the heat insulation part of the stem.

The green laser module package can include a thermistor that measures the working temperature of the laser medium and the optical crystal and delivers the measured working temperature to the second thermoelectric element.

The green laser module package can be in a cylindrical shape.

Another aspect of the invention provides q green laser module package that generates a laser in wavelength range of green visible lights. The green laser module package can include a stem located on a basal surface of the green laser module package, a pumping light source that generates a pumping light, a laser medium that converts the pumping light into an infrared light, an crystal that converts the infrared light into a laser in wavelength range of green visible lights, a thermoelectric element, located on the stem and thermally coupled to the pumping light source, controls working temperature of the pumping light source, a mount, with a surface supporting the pumping light source and another surface attached to the thermoelectric element and a window that transmits the green laser from the optical crystal, toward outside of the green laser module package.

The laser medium and the optical crystal may be arranged to have a same optical axis with the pumping light source.

The thermoelectric element attached surface of the mount can be perpendicular to the pumping light source supporting surface of the mount. The mount may have a full surface contact with the thermoelectric element.

The mount can be composed of a heat-conducting material and the thermoelectric element can be thermally coupled to the pumping light source by the mount. The laser medium and the optical crystal can be mounted on the pumping light source supporting surface of the mount and thermally coupled to the thermoelectric element by the mount.

The green laser module package can include a photo detector that monitors intensity of the green laser.

The green laser module package can include a beam splitter splits the green laser from the optical crystal, partially to the photo detector and partially to the window.

The window can incline in a predetermined angle to the optical axis of the green laser and the photo detector can be aligned to detect a partially reflected green laser from the inclined window.

The green laser module package can be in a cylindrical shape.

Yet another aspect of the invention provides a green laser module package which generates a laser in wavelength range of green visible lights. The green laser module package can include a stem located on a basal surface of the green laser module package, a pumping light source that generates a pumping light, a laser medium that converts the pumping light into an infrared light, an optical crystal that converts the infrared light into a laser in wavelength range of green visible lights, a first thermoelectric element, located on the stem and thermally coupled to the pumping light source, that controls working temperature of the pumping light source, a second thermoelectric element, located on the stem and thermally coupled to the laser medium and the optical crystal, that controls working temperature of the laser medium and the optical crystal, a first mount, with a surface supporting the pumping light source and another surface attached to the first thermoelectric element, a second mount, with a surface supporting the laser medium and the optical crystal and another surface attached to the second thermoelectric element and a window that transmits the green laser from the optical crystal, toward outside of the green laser module package.

The laser medium and the optical crystal may be arranged to have an identical optical axis with the pumping light source.

The thermoelectric element attached surfaces of the first mount and the second mount can be parallel to the basal surface of the green laser module package and the pumping light source supporting surface of the first mount and the laser medium supporting surface of the second mount can be perpendicular to the basal surface.

The laser medium and the optical crystal can be arranged to have an optical axis that is perpendicular to an optical axis of the pumping light source.

The green laser module package can include an optical part that reflects the pumping light to the laser medium, in a perpendicular direction to an optical axis of the pumping light source.

The first mount and the second mount can be composed of a heat-conducting material respectively and the first thermoelectric element the pumping light source by the first mount and the second thermoelectric element can be thermally coupled to the laser medium and the optical crystal by the second mount.

The optical axis of the green laser from the window can be identical to the center axis of the green laser module package.

The green laser module package can include a photo detector that monitors intensity of the green laser. The photo detector comprises a compound semiconductor photo absorption layer having a band gap larger than 1.6 eV.

The compound semiconductor photo absorption layer can be a Si photo absorption layer and the photo detector comprises a dielectric coating having a reflection ratio larger than 0.5 for an infrared lights of about 808 nm and 1064 nm wavelength, and having a reflection ratio smaller than 0.5 for a green light of about 532 nm wavelength.

The compound semiconductor photo absorption layer can be composed of semiconductor selected from the group consisting of CdS, InGaN, AlGaN and their mixtures.

The photo detector can include an optical filter that reflects or absorbs an infrared light of about 808 nm and about 1064 nm wavelength and transmits a green light of about 532 nm wavelength.

The stem can include a heat insulation part between the first thermoelectric element and the second thermoelectric element that separates thermally the first thermoelectric element from the second thermoelectric element.

The green laser module package can include plural leads to apply a driving voltage to the green laser module package and the plural leads can penetrate the heat insulation part of the stem.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 illustrates a green laser module package in a parallel arrange structure according to a first embodiment of the invention.

FIG. 2 illustrates green laser module package in a parallel arrange structure according to a second embodiment of the invention.

FIG. 3 illustrates green laser module package in a parallel arrange structure according to a third embodiment of the invention.

FIG. 4 illustrates a green laser module package in a perpendicular arrange structure according to a fourth embodiment of the invention.

FIG. 5 illustrates the green laser module package of FIG. 4 viewed in a direction.

FIG. 6 illustrates a green laser module package in a perpendicular arrange structure according to a fifth embodiment of the invention.

FIG. 7 illustrates a green laser module package in a perpendicular arrange structure according to a sixth embodiment of the invention.

FIG. 8 illustrates the green laser module package of FIG. 7 viewed in b direction.

FIG. 9 illustrates a green laser module package in a perpendicular arrange structure according to a seventh embodiment of the invention.

### DETAILED DESCRIPTION

Embodiments of the green laser module package according to certain aspects of the invention will be described below in more detail with reference to the accompanying drawings. In the description with reference to the accompanying drawings, those components are rendered the same reference number that are the same or are in correspondence regardless of the figure number, and redundant explanations are omitted. Also, the basic principles will first be described before discussing the preferred embodiments of the invention.

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

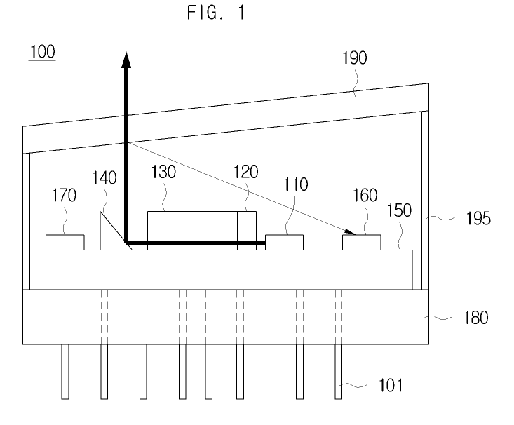

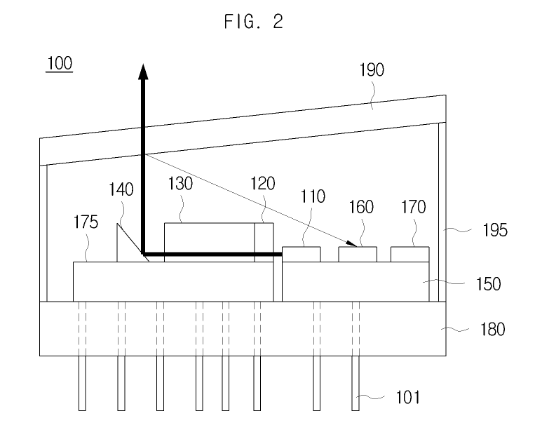

FIG. 1 illustrates a green laser module package in a parallel arrange structure according to a first embodiment of the invention. FIG. 2 illustrates green laser module package in a parallel arrange structure according to a second embodiment of the invention.

Referring to FIG. 1 and FIG. 2, a green laser module package 100 can include a pumping light source 110, a laser medium 120, an optical crystal 130, a reflection mirror 140, a thermoelectric element 150, a photo detector 160 and a thermistor 170. The green laser module package 100 is designed in parallel arrange structure, in which an optical axis of a green laser from the optical crystal 130 is parallel to a basal surface of the package.

The green laser module package 100 can include a stem 180 supporting the green laser module package on the basal surface, plural (about 5˜12) leads 101 to apply a driving voltage to drive each components of the green laser module package, for example a pumping light source 100, thermoelectric element 150, photo detector 160, thermistor 170 and etc, a sealing cap 195 to protect the green laser module, and a window 190 that transmits a green laser generated by the green laser module package toward outside of the green laser module package. The description for general components in a laser module package will be omitted.

The green laser module package 100 can further include some lenses between the pumping light source 110 and the laser medium 120 and between the laser medium 120 and the optical crystal 130. There may be a problem that diffusion of a pumping light from the pumping light source 110 may be lower efficiency of the package. To prevent this problem, a collimation lens or a focusing lens can be used.

The pumping light source 110 generates a pumping light. For example, the pumping light source 110 can generate a pumping light of 808 nm wavelength. A semiconductor laser device using compound semiconductor such as InGaAs (indium gallium arsenide) and a laser diode can be utilized as a pumping light source with no particular limitation.

The laser medium 120 converts a pumping light from the pumping light source 100 into an infrared light. A medium that satisfies a laser oscillation condition can be used as a laser medium including Nd:YVO4 (Neodymium:Yttrium Vanadate), Nd:YAG (Neodymium:Yttrium Aluminum Garnet) and etc. with no particular limitation.

The optical crystal 130 converts an infrared light from the laser medium 120 into a laser in wavelength range of green visible lights. A nonlinear optical crystal (NLO crystal) like a KTP crystal (Potassium-titanyl-phosphate crystal) can be used as an optical crystal. If the pumping light from the pumping light source 110 is of about 808 nm wavelength, the laser medium 120 can convert the pumping light of about 808 nm wavelength to an infrared light of about 1064 nm wavelength and the optical crystal 130 can convert the infrared light of about 1064 nm wavelength into a green laser of about 532 nm wavelength.

The laser medium 120 and the optical crystal 130 may compose a single unit by surface to surface contacting an output surface of the laser medium 120 and an input surface of the optical crystal 130. Also, the laser medium 120 and the optical crystal 130 can be arranged to have an identical optical axis to that of the pumping light source 110 to receive the pumping light from the pumping light source 110 without any loss.

The reflection mirror 140 reflects a green laser from the optical crystal 130 in a direction perpendicular to an optical axis of the pumping light source 110.

The perpendicularly reflected green laser from the reflection mirror 140 is transmitted outside by the window 190, equipped in an upper part of the green laser module package. In case that an optical axis or an optical path of the transmitted green laser by the window intersect perpendicularly with an optical axis or an optical path of the pumping light from the pumping light source 100 or a green laser from the optical crystal 130, the green laser module package can be adopted to color display devices enabling miniaturization and integration with reduced size and volume. It may be preferred that the reflection surface of the reflection mirror 140 inclines 45° from a optical axis of the pumping light source 110.

It is obvious that an optical part which can reflect a green laser from optical crystal 130 perpendicularly can be used with no particular limitation, as an alternative of the reflection mirror.

The thermoelectric element 150 can control working temperature of a component of the green laser module package 100(or the package itself). For example, the thermoelectric element 150 can control a working temperature of each component by thermally coupled to all component which can be affected by heat and temperature of inside and outside of the package (the pumping light source 110, the laser medium 120, the optical crystal 130, the photo detector 160, the thermistor 170 on the thermoelectric element 150) as in FIG. 1. Also, the thermoelectric element 150 can control working temperatures of some of the components (the pumping light source 110, the photo detector 160, the thermistor 170 on the thermoelectric element 150 except the laser medium 120 and the optical crystal 130 on a separate support part 175). Particularly in FIG. 2, considering the pumping light source 110 is more sensitive to temperature than other components like the laser medium 120 and the optical crystal 130, the pumping light source 110 is thermally coupled to the thermoelectric element 150. This can reduce unnecessary power consumption to control temperature than a configuration shown in FIG. 1. The separate support 175 can be a submount which may have a good thermal transfer property like AIN and be connected electrically to the pumping light source 110 with a drive electrode of the pumping light source 110.

Also, ‘thermally coupled’ can mean not only that a component contacts with the thermoelectric element 150 directly but that a certain thermal conduction material is intervened between the component and the thermoelectric element 150. The thermoelectric element 150 is an element using the peltier effect (an effect of a current for a two-metal junction that make one metal emits heat and the other metal absorbs heat). One side of the thermoelectric element 150 can be controlled to emit or absorb heat by changing current direction. Cooling rate and heating rate of the thermoelectric element 150 can be controlled by controlling current amplitude. Thus, by controlling the direction and amplitude of current for the thermoelectric element 150, working temperature of a component can be maintained within normal working range. The thermoelectric element 150 can be composed of KOVAR(a nickel-cobalt ferrous alloy), Cu and Cu—W etc.

The thermistor 170 can measure a working temperature of a component among the pumping light source 110, the laser medium 120, and the optical crystal 130 and transfer the measured temperature to the thermoelectric element 150 to control the working temperature. The thermistor 170 can be placed to any location where it can measure the working temperature of a target component and an optimal location can be found according to design rules.

The photo detector 160 can monitor output power of a green laser from the green laser module package 100 to have a settled desired value. The photo detector 160 can accomplish the monitoring by detecting partially reflected green laser at from the window 190.

A brief description about the photo detector 160 is as followed. A photo detector having a Si substrate as a photo absorption layer is mainly used. The photo detector is desired to measure power of a green light of 532 nm wavelength excluding power of an infrared light of 808 nm or 1064 nm wavelength. Thus, an optical filter can be provided for the photo detector which can reflect or absorb an infrared light of 808 nm and 1064 nm wavelength and transmit a green light of 532 nm wavelength. Also, the photo detector can include a compound semiconductor with a larger band gap than 1.6 eV as a photo absorption layer. For a Si photo absorption layer, a dielectric thin coating of which reflection ratio for an infrared light of 808 nm and 1064 nm wavelength is larger than 0.5 and reflection ratio for a green light of 532 nm wavelength is smaller than 0.5, can be applied to the photo detector. Also, CdS, InGaN and AlGaN, having a good selective permeability for green light, may be used for photo absorption layer.

As in FIG. 1 and FIG. 2, the window 190 can incline a certain angle from a perpendicular plane to an optical axis of a green laser transmitted outside the package. The photo detector 160 can be arranged properly in response to the incline angle of the window 190 to receive a partially reflected green laser from the window 190. The incline angle of the window 190 may be adjusted in response to the arrangement of the photo detector 160.

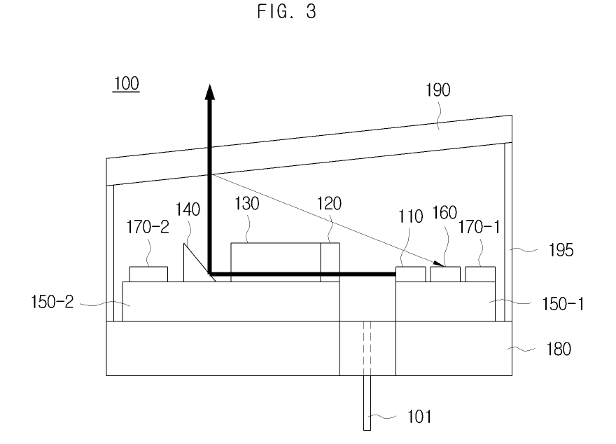

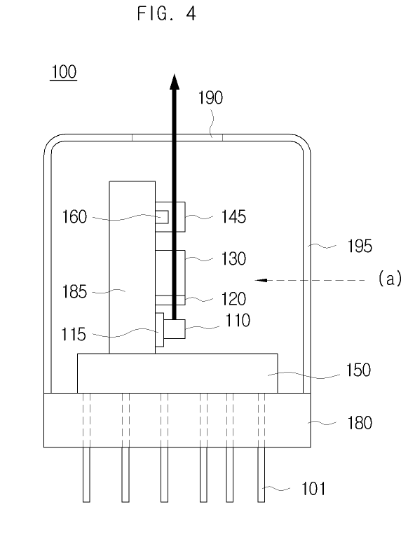

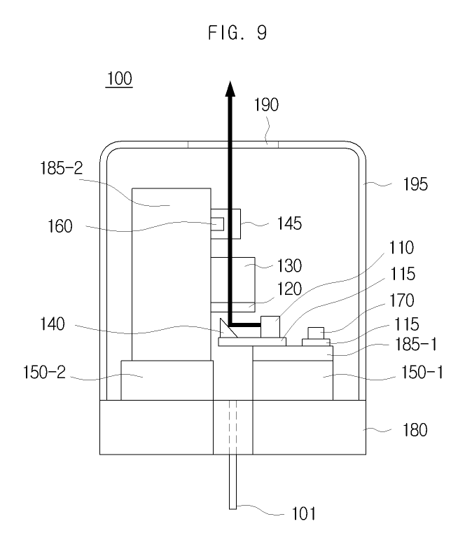

The window 190 can have some inclination in FIG. 1, FIG. 2 and FIG. 3. However, in FIG. 4 and FIG. 9, in case that a beam splitter is provided (for example, provided between the optical crystal 130 and reflection mirror 140) the window 190 can be in a parallel arrangement for green laser detection by the photo detector 160.

The green laser module package 100 can be designed so that an optical axis of the green laser from the window 190 outside the package is identical to the center axis of the package. Also, the green laser module package 100 can be formed in a cylindrical shape. A cylindrical shape of the package and an identical optical axis of output green laser to the center axis of the package can provide a circular symmetry in which the optical axis of the output green laser may not be altered despite rotation of the green laser module package. The circular symmetry can allow more flexible design and arrangement to consist a color display device with the green laser module package.

Also, a cylindrical shape of the package (for example, TO can type) can have advantages in a mass production and a good thermal transfer property as well as the circular symmetry, compared to a rectangular shape (for example, mini DIL type).

Other embodiments of a green laser module package will be described below referring FIG. 3 to FIG. 7. FIG. 3 illustrates green laser module package in a parallel arrange structure according to a third embodiment of the invention.

Referring to FIG. 3, a green laser module package 100 according to a third embodiment of the invention can include a pumping light source 110, a laser medium 120, an optical crystal 130, a reflection mirror 140, a photo detector 160, a stem 180, plural leads 101, a sealing cap 195, a window 190, a first thermoelectric element 150-1, a second thermoelectric element 150-2, a first thermistor 170-1 and a second thermistor 170-2.

The green laser module package 100 in FIG. 3 includes the pumping light source 110 placed on and thermally coupled to the first thermoelectric element 150-1. It also includes the laser medium 120 and the optical crystal 130 placed on and thermally coupled to the second thermoelectric element 150-2. Namely, a working temperature of the pumping light source 110 is controlled by the first thermoelectric element 150-1 and working temperatures of the laser medium 120 and the optical crystal 130 are controlled by the second thermoelectric element 150-2 in a separate control mode. It is a solution considering a normal working temperature range of the pumping light source 110 may be different from a normal working temperature range of the laser medium 120 and the optical crystal 130. It has a benefit of relatively optimized working temperature control for each component. In FIG. 3, there are separate thermistors for 2 separate thermoelectric elements.

It may be preferred that the stem 180 comprises a heat insulation part between the first thermoelectric element 150-1 and the second thermoelectric element 150-2 that separates he first thermoelectric element 150-1 thermally from the second thermoelectric element 150-2. The plural leads 101 may penetrate the heat insulation part of the stem.

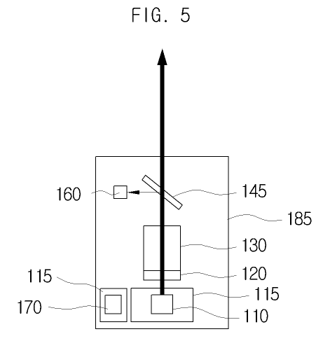

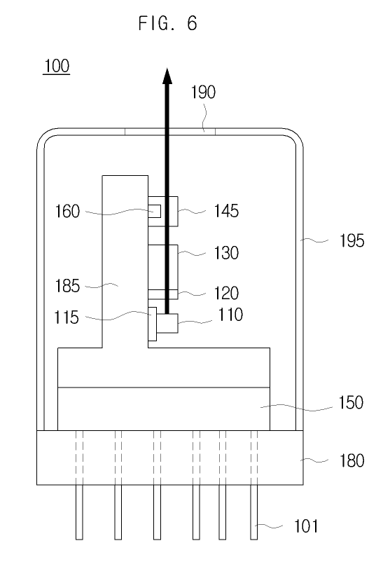

FIG. 4 illustrates a green laser module package in a perpendicular arrange structure according to a fourth embodiment of the invention. FIG. 5 illustrates the green laser module package of FIG. 4 viewed in a direction. FIG. 6 illustrates a green laser module package in a perpendicular arrange structure according to a fifth embodiment of the invention. FIG. 5 illustrates a pumping light source 110, a laser medium 120, an optical crystal 130, a beam splitter 145, a photo detector 160 and a thermistor 170 on a mount 185 viewed in (a) direction in FIG. 4.

Various arrange modes and principals described above referring FIG. 1 to FIG. 3 can be applied to a green laser module package with a perpendicular arrange structure in FIG. 4 to FIG. 7, unless they are not acceptable by a structure difference exceptionally. Thus, different aspects of a perpendicular arrange structure of the green laser module package 100 form a parallel arrange structure, will be describe mainly.

Referring to FIG. 4 to FIG. 6, a green laser module package 100 can include a pumping light source 110, a submount 115, a laser medium 120, an optical crystal 130, a beam splitter 145, a photo detector 160, a mount 185, a stem 180, plural leads 101, a sealing cap 195, a window 190, a thermoelectric element 150 and a thermistor 170. The submount 115 can be installed in a priority considering handling and installing convenience of a mounted component. The submount 115 can have a good thermal transfer property like AIN, provide flatness and be connected electrically to the pumping light source 110 with a drive electrode of the pumping light source 110 by die bonding or wire bonding. The green laser module package 100 in FIG. 4 to FIG. 6, can be designed in a perpendicular arrange structure in which an optical axis of green laser from optical crystal 130 is perpendicular to a basal surface of the package. In a perpendicular arrange structure in FIG. 4 to FIG. 6, the reflection mirror 140 in a parallel arrange structure may be omitted because a optical axis of a green laser from optical crystal 130 is heading for the window 190.

In FIG. 4 to FIG. 6, to construct the perpendicular arrange structure, the mount 185 on the thermoelectric element 150 is provided, mounting the pumping light source 110, the laser medium 120 and the optical crystal 130 on its one surface. The mount 185 has a surface on which the pumping light source 110, the laser medium 120 and the optical crystal 130 are mounted and another surface parallel with the basal surface of the package at which the mount is coupled to the thermoelectric element 150. In case that the mount 185 is made of a good thermal conducting material like Cu, the pumping light source 110, the laser medium 120 and the optical crystal 130 on the mount 185 is thermally coupled to the thermoelectric element 150, so that working temperatures of them can be controlled. Also, a larger contact area between the mount 185 and the thermoelectric element 150 providing a larger heat conduction rate, can improved working temperature control efficiency. For this reason, the mount 130 has a full surface contact with the thermoelectric element 150 in FIG. 6.

The beam splitter 145 can split a green laser from the optical crystal 130 partially to the window 190 and partially to the photo detector 160 (FIG. 5). By utilizing the beam splitter 145, more than 98% of the green laser can be delivered to the window 190 to be transmitted outside the package and less than 2% of the green laser can be delivered to the photo detector 160 so that the photo detector 160 can monitor the output power of the green laser.

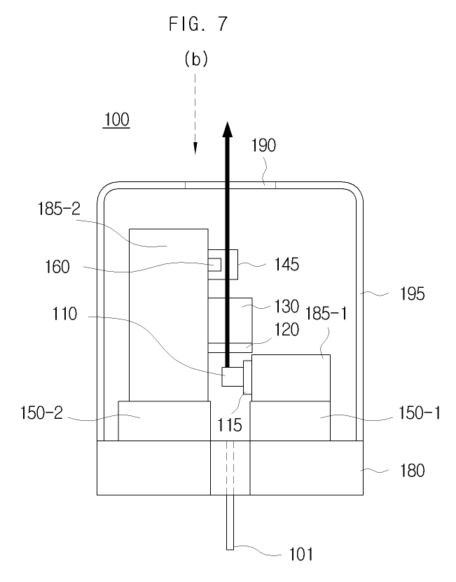

In FIG. 4 and FIG. 5 and also in FIG. 7 to FIG. 9 described below, the photo detector 160 can monitor the output power of the green laser using the beam splitter 145. However, it is obvious that the photo detector 160 can also receive a partially reflected green laser form an inclined window as in FIG. 1 to FIG. 3.

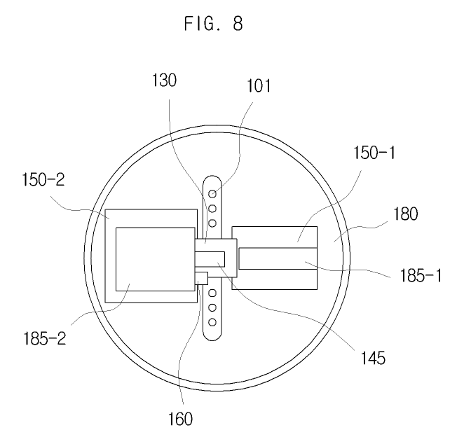

FIG. 7 illustrates a green laser module package in a perpendicular arrange structure according to a sixth embodiment of the invention. FIG. 8 illustrates the green laser module package of FIG. 7 viewed in b direction. FIG. 9 illustrates a green laser module package in a perpendicular arrange structure according to a seventh embodiment of the invention.

Referring to FIG. 7 and FIG. 8, a green laser module package 100 according to a sixth embodiment of the invention can include a pumping light source 110, a submount 115, a laser medium 120, a optical crystal 130, a photo detector 160, a stem 180, plural leads 101, a sealing cap 195, a window 190, a first thermoelectric element 150-1, a second thermoelectric element 150-2, a first mount 185-1 and a second mount 185-2. About the green laser module package 100 illustrated in FIG. 7 and FIG. 8, the pumping light source 110 and the first thermoelectric element 150-1 are thermally coupled, intervened by the first mount 185-1 on the first thermoelectric element 150-1. The laser medium 120 and the optical crystal 130 are thermally coupled to the second thermoelectric element 150-2, intervened by the second mount 185-2 on the second thermoelectric element 150-2. In FIG. 7 and FIG. 8, a separate control mode described above, referring to FIG. 3 is adopted with a perpendicular arrange structure. A working temperature of the pumping light source 110 is controlled by the first thermoelectric element 150-1 and working temperatures of laser medium 120 and optical crystal 130 are controlled by the second thermoelectric element 150-2.

A green laser module package in a perpendicular arrange structure according to a seventh embodiment of the invention illustrated in FIG. 9 adopts a separate control mode and a perpendicular arrange structure as in FIG. 7 and FIG. 8. There are some differences in FIG. 9 from FIG. 7 and FIG. 8 that a reflection mirror 140 is located in front of a pumping light source 110 so that a pumping light from the pumping light source 110 is reflected perpendicularly to its optical axis and the perpendicularly reflected pumping light is headed toward a laser medium 120. In FIG. 7 and FIG. 8, the laser medium 120 and the optical crystal 130 are arranged to have a same optical axis with the pumping light source 110, and in FIG. 9 they are arranged a perpendicular optical axis to that of pumping light source 110.

As described above, a green laser module package according to the invention has a benefit of optimization for working temperature by controlling working temperature of each component separately or concurrently. Also, size and volume of the green laser module package can be minimized by adopting a parallel arrange structure or perpendicular arrange structure.

According to certain embodiments of the invention as set forth above, a green laser module package according to an embodiment of the invention can prevent malfunctions by controlling working temperatures of components of the green laser module and ensure working accuracy, reliability and stability of the, green laser module.

Also, a green laser module package according to an embodiment of the invention can exclude an undesirable affects of external and inner heat by controlling working temperatures of components of the green laser module and minimize size and volume of the green laser module.

A green laser module package according to an embodiment of the invention can be applied to a small color display device, like a mobile phone and a PMP, with minimized size and volume.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A green laser module package which generates a laser in a wavelength range of green visible lights, the green laser module package comprising:
a stem located on a basal surface of the green laser module package;
a pumping light source that generates a pumping light;
a laser medium that converts the pumping light into an infrared light;
an optical crystal that converts the infrared light into a laser in wavelength range of green visible lights;
a first thermoelectric element, located on the stem and thermally coupled to the pumping light source, that controls working temperature of the pumping light source;
an optical part that reflects the green laser from the optical crystal in a perpendicular direction to an optical axis of the pumping light source; and
a window that transmits the perpendicularly reflected green laser, toward outside of the green laser module package.

2. The green laser module package of claim 1, wherein
the pumping light source generates a pumping light of about 808 nm wavelength.

3. The green laser module package of claim 2, wherein
the laser medium converts the pumping light of about 808 nm wavelength into an infrared light of about 1064 nm wavelength and
the optical crystal converts the infrared light of about 1064 nm wavelength into a laser of about 532 nm wavelength.

4. The green laser module package of claim 1, wherein
the laser medium is of Nd:YVO4 (Neodymium:Yttrium Vanadate) and
the optical crystal is of KTP crystal (Potassium-titanyl-phosphate crystal).

5. The green laser module package of claim 4, wherein
an output surface of the laser medium and an input surface of the optical crystal have a surface to surface contact.

6. The green laser module package of claim 1, wherein
the laser medium and the optical crystal are located on the first thermoelectric element, and
the first thermoelectric element controls a working temperature of the laser medium and the optical crystal.

7. The green laser module package of claim 1, wherein
the laser medium and the optical crystal are arranged to have a same optical axis with the pumping light source.

8. The green laser module package of claim 1, wherein
an optical axis of the green laser from the window is identical to the center axis of the green laser module package.

9. The green laser module package of claim 1, further comprising:
a thermistor that measures the working temperature of the pumping light source and delivers the measured working temperature to the first thermoelectric element.

10. The green laser module package of claim 1, further comprising:
a photo detector that monitors intensity of the green laser.

11. The green laser module package of claim 10, wherein,
the photo detector monitors the intensity by detecting a partially reflected green laser from the window.

12. The green laser module package of claim 11, wherein,
the window inclines in a predetermined angle to the optical axis of the green laser and
the photo detector is aligned to detect a partially reflected green laser from the inclined window.

13. The green laser module package of claim 10, wherein
the photo detector comprises a compound semiconductor photoabsorption layer having a bandgap larger than 1.6 eV.

14. The green laser module package of claim 13, wherein
the photo detector comprises a dielectric coating having a reflection ratio larger than 0.5 for an infrared lights of about 808 nm and 1064 nm wavelength, and having a reflection ratio smaller than 0.5 for a green light of about 532 nm wavelength.

15. The green laser module package of claim 13, wherein
the compound semiconductor photo absorption layer is composed of semiconductor selected from the group consisting of CdS, InGaN, AlGaN and mixtures thereof.

16. The green laser module package of claim 10, wherein
the photo detector comprises an optical filter that reflects or absorbs an infrared light of about 808 nm and about 1064 nm wavelength and transmits a green light of about 532 nm wavelength.

17. The green laser module package of claim 1, further comprising:
a second thermoelectric element that controls working temperature of the laser medium and the optical crystal and
the second thermoelectric element controls the working temperature of the laser medium and the optical crystal, separately from the working temperature of the pumping light source.

18. The green laser module package of claim 17, wherein
the stem comprises a heat insulation part between the first thermoelectric element and the second thermoelectric element that separates the first thermoelectric element thermally from the second thermoelectric element.

19. The green laser module package of claim 18, further comprising:
plural leads to apply a driving voltage to the green laser module package and the plural leads penetrates the heat insulation part of the stem.

20. The green laser module package of claim 17, further comprising:
a thermistor that measures the working temperature of the laser medium and the optical crystal and delivers the measured working temperature to the second thermoelectric element.

21. The green laser module package of claim 1, wherein
the green laser module package is in a cylindrical shape.

22. A green laser module package that generates a laser in wavelength range of green visible lights, the green laser module package comprising:
a stem located on a basal surface of the green laser module package;
a pumping light source that generates a pumping light;
a laser medium that converts the pumping light into an infrared light;
an crystal that converts the infrared light into a laser in wavelength range of green visible lights;
a thermoelectric element, located on the stem and thermally coupled to the pumping light source, controls working temperature of the pumping light source;
a mount, with a surface supporting the pumping light source and another surface attached to the thermoelectric element; and
a window that transmits the green laser from the optical crystal, toward outside of the green laser module package.

23. The green laser module package of claim 22, wherein
the laser medium and the optical crystal are arranged to have a same optical axis with the pumping light source.

24. The green laser module package of claim 22, wherein
an optical axis of the green laser from the window is identical to the center axis of the green laser module package.

25. The green laser module package of claim 22, wherein
the thermoelectric element attached surface of the mount is perpendicular to the pumping light source supporting surface of the mount.

26. The green laser module package of claim 22, wherein
the mount has a full surface contact with the thermoelectric element.

27. The green laser module package of claim 22, wherein
the mount is composed of a heat-conducting material and
the thermoelectric element is thermally coupled to the pumping light source by the mount.

28. The green laser module package of claim 27, wherein
the laser medium and the optical crystal is mounted on the pumping light source supporting surface of the mount and thermally coupled to the thermoelectric element by the mount.

29. The green laser module package of claim 22, further comprising:
a photo detector that monitors intensity of the green laser.

30. The green laser module package of claim 29, further comprising:
a beam splitter splits the green laser from the optical crystal, partially to the photo detector and partially to the the window.

31. The green laser module package of claim 29, wherein
the window inclines in a predetermined angle to the optical axis of the green laser and
the photo detector is aligned to detect a partially reflected green laser from the inclined window.

32. The green laser module package of claim 22, wherein
the green laser module package is in a cylindrical shape.

33. A green laser module package which generates a laser in wavelength range of green visible lights, the green laser module package comprising:
a stem located on a basal surface of the green laser module package;
a pumping light source that generates a pumping light;
a laser medium that converts the pumping light into an infrared light;
an optical crystal that converts the infrared light into a laser in wavelength range of green visible lights;
a first thermoelectric element, located on the stem and thermally coupled to the pumping light source, that controls working temperature of the pumping light source;
a second thermoelectric element, located on the stem and thermally coupled to the laser medium and the optical crystal, that controls working temperature of the the laser medium and the optical crystal;
a first mount, with a surface supporting the pumping light source and another surface attached to the first thermoelectric element;
a second mount, with a surface supporting the laser medium and the optical crystal and another surface attached to the second thermoelectric element; and
a window that transmits the green laser from the optical crystal, toward outside of the green laser module package.

34. The green laser module package of claim 33, wherein
the laser medium and the optical crystal is arranged to have an identical optical axis with the pumping light source.

35. The green laser module package of claim 33, wherein
the thermoelectric element attached surfaces of the first mount and the second mount are parallel to the basal surface of the the green laser module package and
the pumping light source supporting surface of the first mount and the laser medium supporting surface of the second mount are perpendicular to the basal surface.

36. The green laser module package of claim 33, wherein
the laser medium and the optical crystal are arranged to have an optical axis that is perpendicular to an optical axis of the pumping light source.

37. The green laser module package of claim 33, further comprising:
an optical part that reflects the pumping light to the laser medium, in a perpendicular direction to an optical axis of the pumping light source.

38. The green laser module package of claim 33, wherein
the first mount and the second mount are composed of a heat-conducting material respectively and
the first thermoelectric element the pumping light source by the first mount, and the second thermoelectric element is thermally coupled to the laser medium and the optical crystal by the second mount.

39. The green laser module package of claim 33, wherein
an optical axis of the green laser from the window is identical to the center axis of the green laser module package.

40. The green laser module package of claim 33, further comprising:
a photo detector that monitors intensity of the green laser.

41. The green laser module package of claim 40, wherein
the photo detector comprises a compound semiconductor photoabsorption layer having a bandgap larger than 1.6 eV.

42. The green laser module package of claim 41, wherein
the compound semiconductor photo absorption layer is a Si photo absorption layer and
the photo detector comprises a dielectric coating having a reflection ratio larger than 0.5 for an infrared lights of about 808 nm and 1064 nm wavelength, and having a reflection ratio smaller than 0.5 for a green light of about 532 nm wavelength.

43. The green laser module package of claim 41, wherein
the compound semiconductor photoabsorption layer is composed of semiconductor selected from the group consisting of CdS, InGaN, AlGaN and mixtures thereof.

44. The green laser module package of claim 40, wherein
the photo detector comprises an optical filter that reflects or absorbs an infrared light of about 808 nm and about 1064 nm wavelength and transmits a green light of about 532 nm wavelength.

45. The green laser module package of claim 43, wherein
the stem comprises a heat insulation part between the first thermoelectric element and the second thermoelectric element that separates thermally the first thermoelectric element from the second thermoelectric element.

46. The green laser module package of claim 45, further comprising:
plural leads to apply a driving voltage to the green laser module package and
the plural leads penetrates the heat insulation part of the stem.
